(19) United States
(12) Patent Application Publication
(10) Pub. No.: US 2015/0348475 A1
(43) Pub. Date: Dec. 3, 2015

(54) CIRCUIT STRUCTURE OF LIQUID CRYSTAL PANEL AND DRIVING METHOD OF LIQUID CRYSTAL PANEL

(71) Applicant: Shenzhen China Star Optoelectronics Technology Co. Ltd., Shenzhen, Guangdong (CN)

(72) Inventor: Jiang ZHU, Shenzhen, Guangdong (CN)

(73) Assignee: Shenzhen China Star Optoelectronics Technology Co. Ltd., Shenzhen, Guangdong (CN)

(21) Appl. No.: 14/374,517

(22) PCT Filed: Jun. 12, 2014
(86) PCT No.: PCT/CN2014/079707

§ 371 Date: Jul. 24, 2014

(30) Foreign Application Priority Data
May 26, 2014 (CN) 201410226565.1

(51) Int. Cl. G09G 3/36

(52) U.S. Cl. CPC G09G 3/3607; G09G 2330/00; G09G 2320/02

(57) ABSTRACT

The present invention provides a circuit structure of a liquid crystal panel and a driving method of a liquid crystal panel. The circuit structure of a liquid crystal panel comprises: a data driving control chip having n data signal output lines, a column driving scan chip, M triggers, M liquid crystal pixel array areas corresponding to the M triggers, a dot clock signal (CLK) and a common voltage (VCOM); each of the liquid crystal pixel array areas comprises: (n×N) liquid crystal pixels, N scan signal lines, and n liquid crystal pixel data signal lines; By sequentially triggering the triggers, the liquid crystal pixels of the M liquid crystal pixel array areas are sequentially charged without interferes with one another. The present invention also provides a corresponding driving method of a liquid crystal panel. The circuit structure of the liquid crystal panel and the driving method of the liquid crystal panel are capable of reducing the amount of the data signal output lines of the data driving control chip. Meanwhile, the color shift caused by the varying charges to the left, right areas and the middle areas of the liquid crystal panel can be solved.

### FIELD OF THE INVENTION

The present invention relates to a technology field of liquid crystal display panel, and more particularly to a circuit structure of a liquid crystal panel and a driving method of a liquid crystal panel.

### BACKGROUND OF THE INVENTION

For a common liquid crystal display, a liquid crystal layer with dielectric anisotropy is formed between the upper substrate and lower substrate. After that, the electric field density to the liquid crystal layer is controlled to change the alignment of the liquid crystal molecules. Therefore, an ideal, desired image is shown with the adjustment of the transmission light through the upper substrate, the surface of the display. The liquid crystal display comprises a liquid substrate having a plurality of pixels for showing the image, driving circuits for driving the liquid crystal panel and a back light module of projecting light to the liquid crystal panel. The equivalent circuit of each pixel composing the liquid crystal panel comprises gate lines and data lines crossing with one another, thin film transistors and pixel electrodes respectively arranged at the crossing points of the gate lines and data lines, liquid crystal capacitors in accordance with the pixel units and storage capacitors.

The liquid crystal display TV has been widely applied because of its light weight and low power consumption. With the economic development, the large size, high resolution LCD TV has become more and more popular. However, the requirement for the amount of the output lines of the data driving control chip for the liquid crystal panel is increased accordingly and the manufacture cost gets higher along with the resolution gets higher. Therefore, it is a demanding prompt solution in this field that how to achieve higher resolution with less output lines.

For now, a Tri-gate design and a HSD (Half Source Driving) design are capable of efficiently decreasing the amount of the output lines of the data driving chip. Tri-gate technology is a kind of a special stack up structure. Fin-tailplane compositions are added on three faces of conducting channel of the Tri-gates to rule out the surplus heat. With the high combination of gate isolation and the strained silicon, longer battery life and better performance can be possible for the mobile devices. However, both these two technologies requires increase of the amount of the output lines of the scan driving chip accordingly and the resistance differences from the data driving chip to the pixels in all rows of the liquid crystal panel become larger. The color shift appears and seriously affects the image quality of the liquid crystal panel.

### SUMMARY OF THE INVENTION

An objective of the present invention is to provide a circuit structure of a liquid crystal panel, the liquid crystal pixels of the M liquid crystal pixel array areas are sequentially charged without interferes with one another by sequentially triggering the M triggers. The amount of the data signal output lines of the data driving control chip is enormously reduced and the color shift of the liquid crystal panel is efficiently improved.

Another objective of the present invention is to provide a driving method of a liquid crystal panel which is capable of achieving higher resolution with a driving chip having fewer output lines. Therefore, the required manufacture cost of the driving chip in the liquid crystal panel is reduced and the color shift of the liquid crystal panel is efficiently improved.

For realizing the aforesaid objective, the present invention provides a circuit structure of a liquid crystal panel, comprising: a data driving control chip having n data signal output lines (S1˜S(n)), a column driving scan chip, M triggers (trigger 1˜triggerM), M liquid crystal pixel array areas (Section1˜Section(M)) corresponding to the M triggers, a dot clock signal (CLK) and a common voltage (VCOM);

each of the liquid crystal pixel array areas comprises: (n×N) liquid crystal pixels (P), N scan signal lines (Scan1˜Scan(N)), and n liquid crystal pixel data signal lines (Line1˜Line(n)); n liquid crystal pixels (P) are arranged along a column direction; N liquid crystal pixels (P) are arranged along a row direction; the liquid crystal pixel (P) comprises a pixel transistor (Tr) and a pixel electrode (A); the pixel transistor (Tr) comprises a gate (g), a source (s) and a drain (d); one end of the pixel electrode (A) is electrically connected to the drain (d) of the pixel transistor (Tr), and the other end of the pixel electrode (A) is electrically connected to the common voltage (VCOM); the gates (g) of the pixel transistor (Tr) arranged in the same column are connected to some common coupling of the scan signal line (Scan1˜Scan(N)); the sources of the pixel transistor arranged in the same row are connected to some common coupling of the liquid crystal pixel data signal lines (Line1˜Line(n)). The column driving scan chip and the scan signal lines (Scan1˜Scan(N)) are electrically connected, and the column driving scan chip activates the scan signal lines (Scan1˜Scan(N)) sequentially and selectively. Specifically, the column driving scan chip comprises N grade shift registers. The scan signal lines (Scan1˜Scan(N)) becomes activated state or non activated state according to the output signals from respective grades of the shift registers. Each of the triggers is positioned between a data driving control chip and a liquid crystal pixel data signal lines (Line1˜Line(n)) in a liquid crystal pixel array area, and electrically connected to each of the data signal output lines (S1˜S(n)), the dot clock signal (CLK) and the liquid crystal pixel data signal lines (Line1˜Line(n)) of the corresponding liquid crystal pixel array area of the data driving control chip; the data signal output lines (S1˜S(n)) are one by one correspondingly and electrically connected to the liquid crystal pixel data signal lines (Line1˜Line(n)) of the corresponding liquid crystal pixel array areas. The M triggers (trigger 1˜triggerM) are sequentially connected with one another to form M grade shift registers; the clock signal (CLK) is provide to a serial data clock end of the M grade shift registers.

The M triggers (trigger 1˜triggerM) are controlled by the dot clock signal (CLK) and sequentially triggered.

The liquid crystal pixel data signal lines (Line1˜Line(n)) in the liquid crystal pixel array areas corresponding to each of the triggers are controlled to be in conducted state together.

The triggers control the data driving control chip to charge the liquid crystal pixels (P) of the corresponding liquid crystal pixel array areas.

The trigger comprises: a trigger control module and a trigger output module electrically connected to the trigger control module; the trigger control module comprises a first transistor (M1), a second transistor (M2), a third transistor (M3), a fourth transistor (M4) and a capacitor (C1); the first transistor (M1) comprises a first gate (g1), a first source (s1) and a first drain (d1); the second transistor (M2) comprises a second gate (g2), a second source (s2) and a second drain (d2); the third transistor (M3) comprises a third gate (g3), a third source (s3) and a third drain (d3); the fourth transistor comprises a fourth gate (g4), a fourth source (s4) and a fourth drain (d4); the trigger output module comprises n output transistors (T1˜T(n)), and the output transistors (T1˜T(n)) comprise a gates (g1′˜gn′), a sources (s1′˜sn′) and a drains (d1′˜dn′);

the first gate (g1) and the first source (s1) are electrically connected and then form a (m−1)th pulse signal output end Out (m−1), and the second drain (d2) is electrically connected to a negative electrode (Vss) of a power supply, and the third source (s3) is electrically connected to the dot clock signal (CLK), and the fourth drain (d4) is electrically connected to the negative electrode (Vss) of the power supply, and the second gate (g2) and the fourth gate (g4) are electrically connected and then form a (m+1)th pulse signal output end Out (m+1), and one end of the capacitor (C1) is electrically connected to the first drain (d1) and the second source (s2), and then connected to the third gate (g3) to form a connection point (a1), and the other end of the capacitor (C1) is electrically connected to the third drain (d3) and the fourth source (s4) and then form a mth pulse signal output end Out (m), and the gates (g1′˜gn′) of the n output transistors (T1˜Tn) are electrically connected to the mth pulse signal output end Out (m), the sources (s1′˜sn′) of the n output transistors (T1˜T(n)) are one by one correspondingly and electrically connected to the data signal output lines (S1˜S(n)) of the data driving control chip 1, and the drains (d1′˜dn′) of the n output transistors (T1˜T(n)) are correspondingly and electrically connected to the liquid crystal pixel data signal lines (Line1˜Line(n)) of the mth corresponding liquid crystal pixel array area (Section(m)).

The present invention also provides a circuit structure of a liquid crystal panel, comprising: a data driving control chip having n data signal output lines (S1˜S(n)), a column driving scan chip, M triggers, M liquid crystal pixel array areas corresponding to the M triggers, a dot clock signal and a common voltage;

each of the liquid crystal pixel array areas comprises: (n×N) liquid crystal pixels, N scan signal lines, and n liquid crystal pixel data signal lines; n liquid crystal pixels are arranged along a column direction; N liquid crystal pixels are arranged along a row direction; the liquid crystal pixel comprises a pixel transistor and a pixel electrode; the pixel transistor comprises a gate, a source and a drain; one end of the pixel electrode is electrically connected to the drain of the pixel transistor, and the other end of the pixel electrode is electrically connected to the common voltage; the gates of the pixel transistor arranged in the same column are connected to some common coupling of the scan signal line; the sources of the pixel transistor arranged in the same row are connected to some common coupling of the liquid crystal pixel data signal lines;

the column driving scan chip and the scan signal lines are electrically connected, and the column driving scan chip activates the scan signal lines sequentially and selectively;

each of the triggers is positioned between a data driving control chip and a liquid crystal pixel data signal line in a liquid crystal pixel array area, and electrically connected to each of the data signal output lines, the dot clock signal and the liquid crystal pixel data signal line of the corresponding liquid crystal pixel array area of the data driving control chip; the data signal output lines are one by one correspondingly and electrically connected to the liquid crystal pixel data signal lines of the corresponding liquid crystal pixel array areas;

wherein the M triggers are sequentially connected with one another, and the M triggers are controlled by the dot clock signal and sequentially triggered;

wherein the liquid crystal pixel data signal lines in the liquid crystal pixel array areas corresponding to each of the triggers are controlled to be in conducted state together;

wherein the liquid crystal pixel data signal lines in the liquid crystal pixel array areas corresponding to each of the triggers are controlled to be in conducted state together;

wherein the trigger comprises: a trigger control module and a trigger output module electrically connected to the trigger control module; the trigger control module comprises a first transistor, a second transistor, a third transistor, a fourth transistor and a capacitor; the first transistor comprises a first gate, a first source and a first drain; the second transistor comprises a second gate, a second source and a second drain; the third transistor comprises a third gate, a third source and a third drain; the fourth transistor comprises a fourth gate, a fourth source and a fourth drain; the trigger output module comprises n output transistors, and the output transistors comprise gates, sources and drains;

the first gate and the first source are electrically connected and then form a (m−1)th pulse signal output end Out (m−1), and the second drain is electrically connected to a negative electrode of a power supply, and the third source is electrically connected to the dot clock signal, and the fourth drain is electrically connected to the negative electrode of the power supply, and the second gate and the fourth gate are electrically connected and then form a (m+1)th pulse signal output end Out (m+1), and one end of the capacitor is electrically connected to the first drain and the second source, and then connected to the third gate to form a connection point, and the other end of the capacitor is electrically connected to the third drain and the fourth source and then form a mth pulse signal output end Out (m), and the gates of the n output transistors are electrically connected to the mth pulse signal output end Out (m), the sources of the n output transistors are one by one correspondingly and electrically connected to the data signal output lines of the data driving control chip, and the drains of the n output transistors are correspondingly and electrically connected to the liquid crystal pixel data signal lines of the mth corresponding liquid crystal pixel array area.

The present invention also provides a driving method of a liquid crystal panel, comprising:

step 100, providing a data driving control chip having n data signal output lines (S1˜S(n)), a column driving scan chip, M triggers (trigger 1˜triggerM), M liquid crystal pixel array areas (Section1˜Section(M)) corresponding to the M triggers;

step 110, each of the liquid crystal pixel array areas comprises: (n×N) liquid crystal pixels (P), N scan signal lines (Scan1˜Scan(N)), and n liquid crystal pixel data signal lines (Line1˜Line(n)); n liquid crystal pixels (P) are arranged along a column direction; N liquid crystal pixels (P) are arranged along a row direction; the liquid crystal pixel (P) comprises a pixel transistor (Tr) and a pixel electrode (A); the pixel transistor (Tr) comprises a gate (g), a source (s) and a drain (d); one end of the pixel electrode (A) is electrically connected to the drain (d) of the pixel transistor (Tr), and the other end of the pixel electrode (A) is electrically connected to the common voltage (VCOM); the gates (g) of the pixel transistor (Tr) arranged in the same column are connected to some common coupling of the scan signal line (Scan1˜Scan(N)); the sources of the pixel transistor arranged in the same row are connected to some common coupling of the liquid crystal pixel data signal lines (Line1˜Line(n));

step 120, the column driving scan chip and the scan signal lines (Scan1˜Scan(N)) are electrically connected, and the column driving scan chip activates the scan signal lines (Scan1˜Scan(N)) sequentially and selectively;

step 130, each of the triggers is positioned between a data driving control chip and a liquid crystal pixel data signal lines (Line1˜Line(n)) in a liquid crystal pixel array area, and electrically connected to each of the data signal output lines (S1˜S(n)) and the liquid crystal pixel data signal lines (Line1˜Line(n)) of the corresponding liquid crystal pixel array area of the data driving control chip; the data signal output lines (S1˜S(n)) are one by one correspondingly and electrically connected to the liquid crystal pixel data signal lines (Line1˜Line(n)) of the corresponding liquid crystal pixel array areas;

step 140, sequentially connecting the M triggers (trigger 1˜triggerM) with one another.

The M triggers (trigger 1˜triggerM) are controlled by the dot clock signal (CLK) and sequentially triggered.

The liquid crystal pixel data signal lines (Line1˜Line(n)) in the liquid crystal pixel array areas corresponding to each of the triggers are controlled to be in conducted state together.

The triggers control the data driving control chip to charge the liquid crystal pixels (P) of the respective liquid crystal pixel array areas.

The trigger comprises: a trigger control module and a trigger output module electrically connected to the trigger control module;

the first gate (g1) and the first source (s1) are electrically connected and then form a (m−1)th pulse signal output end Out (m−1), and the second drain (d2) is electrically connected to a negative electrode (Vss) of a power supply, and the third source (s3) is electrically connected to the dot clock signal (CLK), and the fourth drain (d4) is electrically connected to the negative electrode (Vss) of the power supply, and the second gate (g2) and the fourth gate (g4) are electrically connected and then form a (m+1)th pulse signal output end Out (m+1), and one end of the capacitor (C1) is electrically connected to the first drain (d1)) and the second source (s2), and then connected to the third gate (g3) to form a connection point (a1), and the other end of the capacitor (C1) is electrically connected to the third drain (d3) and the fourth source (s4) and then form a mth pulse signal output end Out (m), and the gates (g1′˜gn′) of the n output transistors (T1˜Tn) are electrically connected to the mth pulse signal output end Out (m), the sources (s1′˜sn′) of the n output transistors (T1˜T(n)) are one by one correspondingly and electrically connected to the data signal output lines (S1˜S(n)) of the data driving control chip 1, and the drains (d1′˜dn′) of the n output transistors (T1˜T(n)) are correspondingly and electrically connected to the liquid crystal pixel data signal lines (Line1˜Line(n)) of the mth corresponding liquid crystal pixel array area (Section(m)).

The benefit of the present invention is: the present invention provides a circuit structure of a liquid crystal panel and a circuit structure of a liquid crystal panel. By positioning M triggers between liquid crystal pixel data signal lines and the data driving control chip, the liquid crystal panel is correspondingly divided into M liquid crystal pixel array areas. The triggers are sequentially triggered and then sequentially charging the liquid crystal pixels of the M liquid crystal pixel array areas can be achieved without interferes with one another. Charging the liquid crystal pixels of the liquid crystal panel by utilizing the n data signal output lines of the data driving control chip is realized to enormously reduce the amount of the data signal output lines of the data driving control chip and the manufacture cost of the liquid crystal panel; besides, the activation timing of the triggers is related to the dot clock signal (CLK). Therefore, the charging time of data driving control chip to the liquid crystal pixels of some liquid crystal pixel array areas become controllable. Consequently, the color shift caused by the varying charges to the left, right areas and the middle areas of the liquid crystal panel can be solved.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution, as well as beneficial advantages, of the present invention will be apparent from the following detailed description of an embodiment of the present invention, with reference to the attached drawings.

In the attached drawings,

FIG. 1 is a diagram of a circuit structure of liquid crystal panel according to the present invention;

FIG. 2a is a design diagram of the triggers in the liquid crystal panel shown in FIG. 1;

FIG. 2b is a sequence diagram of the trigger shown in FIG. 2a;

FIG. 3 is a diagram of showing the interconnections of the triggers in the liquid crystal panel shown in FIG. 1;

FIG. 4 is a sequence diagram of the liquid crystal panel shown in FIG. 1.

### DETAILED DESCRIPTION OF PREFERRED EMBODIMENTS

Embodiments of the present invention are described in detail with the technical matters, structural features, achieved objects, and effects with reference to the accompanying drawings as follows.

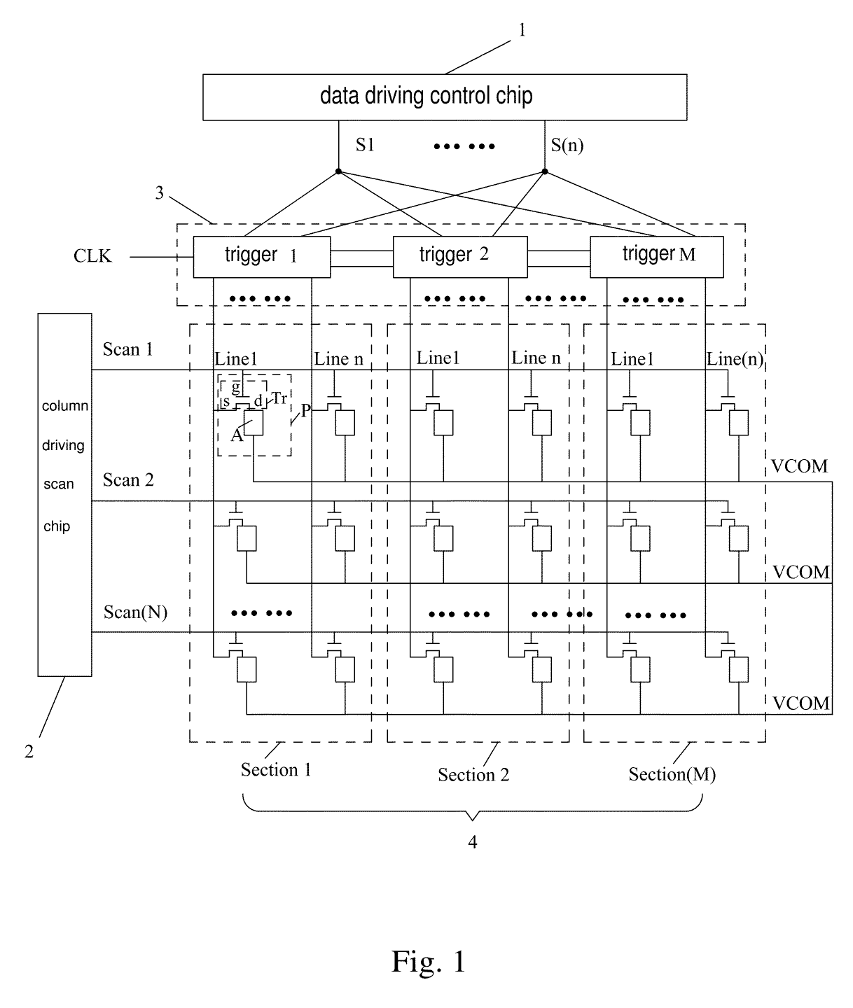

Please refer to FIG. 1. The present invention provides a circuit structure of a liquid crystal panel, comprising: a data driving control chip 1 having n data signal output lines (S1˜S(n)), a column driving scan chip 2, M triggers 3 (trigger 1˜triggerM), M liquid crystal pixel array areas 4 (Section1˜Section(M)) corresponding to the M triggers, a dot clock signal (CLK) and a common voltage (VCOM);

each of the liquid crystal pixel array areas comprises: (n×N) liquid crystal pixels (P), N scan signal lines (Scan1˜Scan(N)), and n liquid crystal pixel data signal lines (Line1˜Line(n)); n liquid crystal pixels (P) are arranged along a column direction; N liquid crystal pixels (P) are arranged along a row direction; the liquid crystal pixel (P) comprises a pixel transistor (Tr) and a pixel electrode (A); the pixel transistor (Tr) comprises a gate (g), a source (s) and a drain (d); one end of the pixel electrode (A) is electrically connected to the drain (d) of the pixel transistor (Tr), and the other end of the pixel electrode (A) is electrically connected to the common voltage (VCOM); the gates (g) of the pixel transistor (Tr) arranged in the same column are connected to some common coupling of the scan signal line (Scan1˜Scan(N)); the sources of the pixel transistor arranged in the same row are connected to some common coupling of the liquid crystal pixel data signal lines (Line1˜Line(n)).

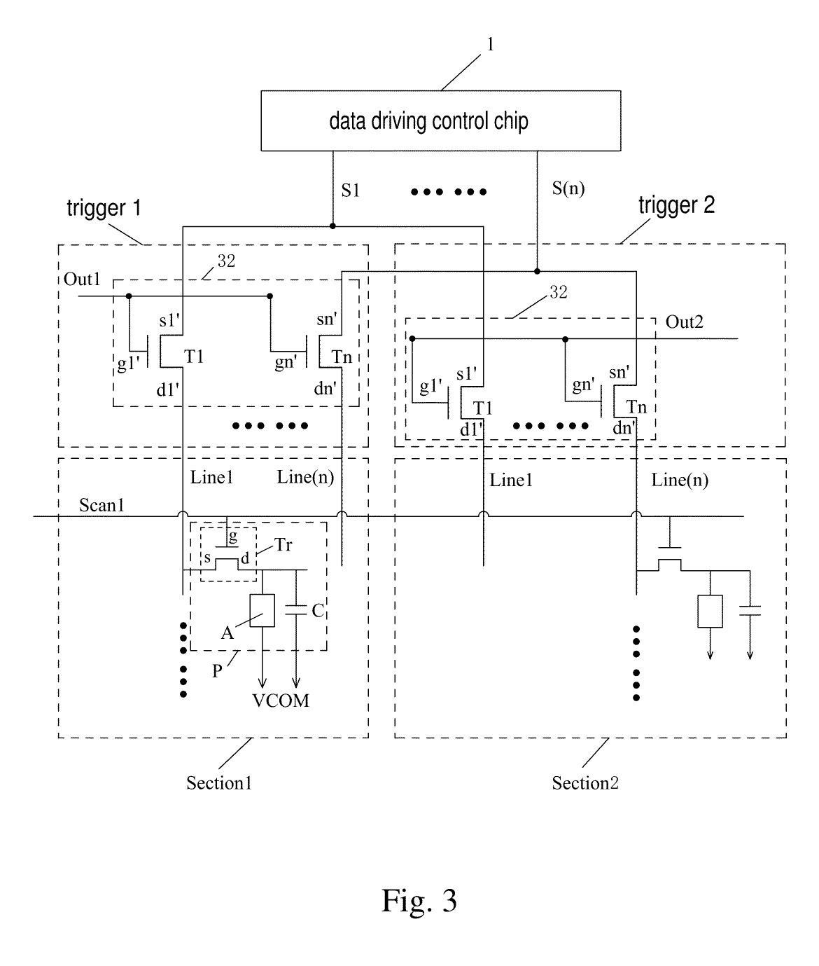

FIG. 1 which shows the liquid crystal pixel (P) is a simple diagram. Please refer to the liquid crystal pixel (P) shown in FIG. 3 and the liquid crystal pixel (P) arranged in the first column and first row in the first liquid crystal pixel array area (Section1) is illustrated. The liquid crystal pixel (P) comprises a pixel transistor (Tr), a pixel electrode (A) and a storage capacitor (C); the pixel transistor (Tr) comprises a gate (g), a source (s) and a drain (d); the gate (g) of the pixel transistor (Tr) and the scan signal line (Scan1) is electrically connected, and the source (s) of the pixel transistor (Tr) and the first liquid crystal pixel data signal line (Line 1), and the drain (d) of the pixel transistor (Tr) is electrically connected to one end of the liquid crystal pixel (P) and the upper electrode of the storage capacitor (C), and the other end of the liquid crystal pixel (P) is electrically connected to a common voltage (VCOM), and the lower electrode of the storage capacitor (C) is electrically connected to the common voltage (VCOM); the storage capacitor (C) is employed for maintaining the state of the applying signal to the pixel transistor (Tr) until the next signal is applied. The column driving scan chip 2 is electrically connected to the scan signal lines (Scan1˜Scan(N)), and the column driving scan chip 2 sequentially activates the scan signal lines (Scan1˜Scan(N)). Specifically, the column driving scan chip 2 comprises N grade shift registers. The scan signal lines (Scan1˜Scan(N)) becomes activated state or non activated state according to the output signals from respective grades of the shift registers.

On the TFT glass substrate of the liquid crystal panel, each of the triggers is positioned between a data driving control chip 1 and a liquid crystal pixel data signal lines (Line1˜Line(n)) in a liquid crystal pixel array area, and electrically connected to each of the data signal output lines (S1˜S(n)), the dot clock signal (CLK) and the liquid crystal pixel data signal lines (Line1˜Line(n)) of the corresponding liquid crystal pixel array area of the data driving control chip 1; the data signal output lines (S1˜S(n)) are one by one correspondingly and electrically connected to the liquid crystal pixel data signal lines (Line1˜Line(n)) of the corresponding liquid crystal pixel array areas. The M triggers (trigger 1˜triggerM) are sequentially connected with one another to form M grade shift registers; the clock signal (CLK) is provide to a serial data clock end of the M grade shift registers. The M triggers 3 (trigger 1˜triggerM) are controlled by the dot clock signal (CLK) and sequentially triggered.

The liquid crystal pixel data signal lines (Line1˜Line(n)) in the liquid crystal pixel array areas corresponding to each of the triggers are controlled to be in conducted state together.

Each of the triggers controls the data driving control chip 1 to charge the liquid crystal pixels (P) of the corresponding liquid crystal pixel array area.

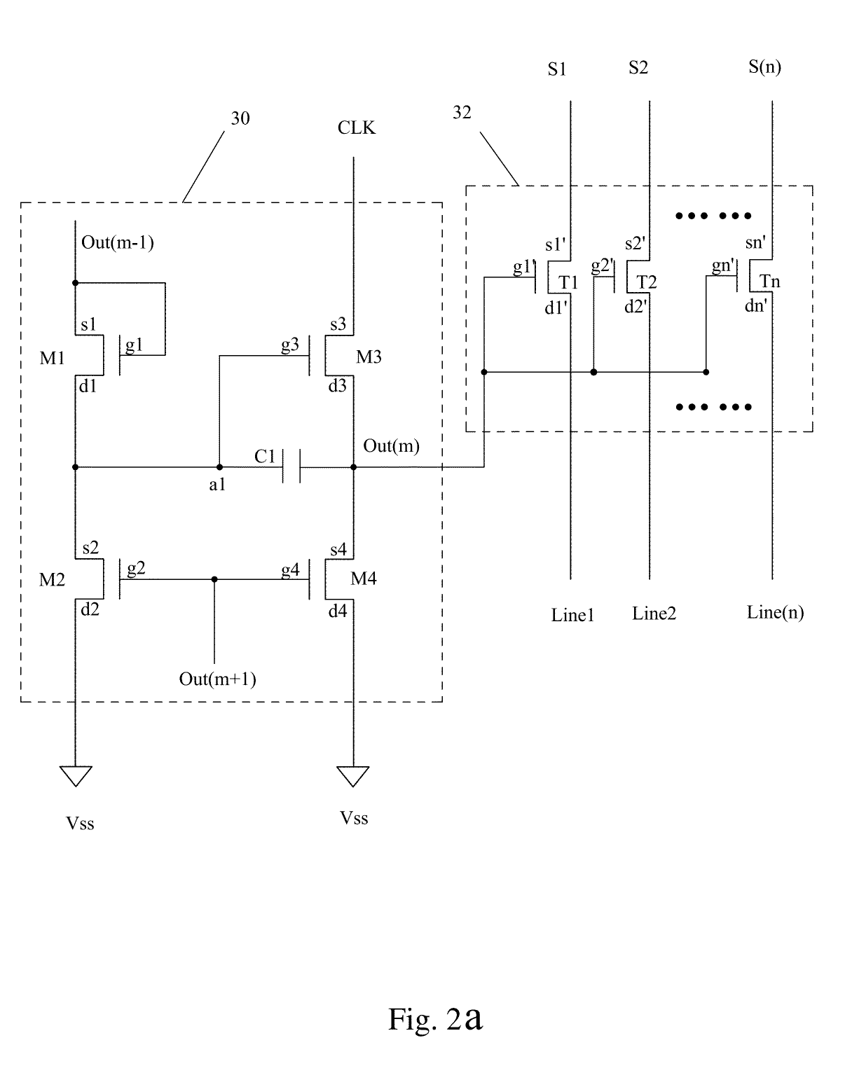

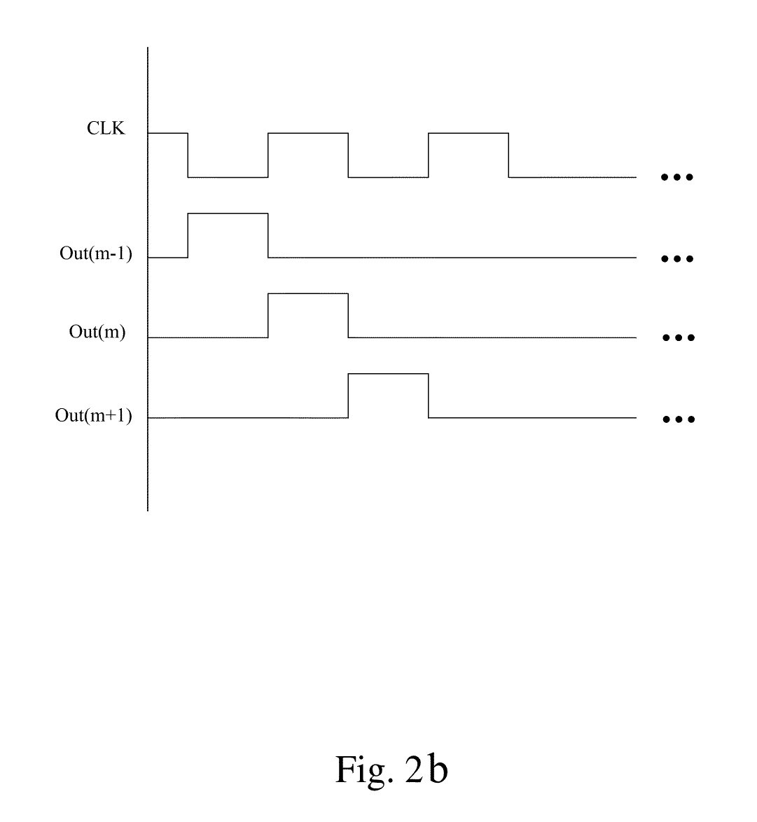

Please refer to FIG. 2a in conjunction with FIG. 1. FIG. 2a is a design diagram of the triggers in the liquid crystal panel shown in FIG. 1. The functioning trigger m is illustrated. The trigger m comprises: a trigger control module 30 and a trigger output module 32 electrically connected to the trigger control module 30; the trigger control module 30 comprises a first transistor (M1), a second transistor (M2), a third transistor (M3), a fourth transistor (M4) and a capacitor (C1); the first transistor (M1) comprises a first gate (g1), a first source (s1) and a first drain (d1); the second transistor (M2) comprises a second gate (g2), a second source (s2) and a second drain (d2); the third transistor (M3) comprises a third gate (g3), a third source (s3) and a third drain (d3); the fourth transistor comprises a fourth gate (g4), a fourth source (s4) and a fourth drain (d4); the trigger output module comprises n output transistors (T1˜T(n)), and the output transistors (T1˜T(n)) comprise a gates (g1′˜gn′), a sources (s1′˜sn′) and a drains (d1′˜dn′).

The first gate (g1) and the first source (s1) are electrically connected and then form a (m−1)th pulse signal output end Out (m−1), and the second drain (d2) is electrically connected to a negative electrode (Vss) of a power supply, and the third source (s3) is electrically connected to the dot clock signal (CLK), and the fourth drain (d4) is electrically connected to the negative electrode (Vss) of the power supply, and the second gate (g2) and the fourth gate (g4) are electrically connected and then form a (m+1)th pulse signal output end Out (m+1), and one end of the capacitor (C1) is electrically connected to the first drain (d1) and the second source (s2), and then connected to the third gate (g3) to form a connection point (a1), and the other end of the capacitor (C1) is electrically connected to the third drain (d3) and the fourth source (s4) and then form a mth pulse signal output end Out (m), and the gates (g1′˜gn′) of the n output transistors (T1˜Tn) are electrically connected to the mth pulse signal output end Out (m), the sources (s1′˜sn′) of the n output transistors (T1˜T(n)) are one by one correspondingly and electrically connected to the data signal output lines (S1˜S(n)) of the data driving control chip 1, and the drains (d1′˜dn′) of the n output transistors (T1˜T(n)) are correspondingly and electrically connected to the liquid crystal pixel data signal lines (Line1˜Line(n)) of the mth corresponding liquid crystal pixel array area (Section(m)).

Please refer to FIG. 2b in conjunction with FIG. 1 and FIG. 2a. FIG. 2b is a sequence diagram of the trigger shown in FIG. 2a. The working process of the triggers according to the present invention is: the (m−1)th pulse signal output end Out (m−1) is a high level pulse signal when the (m−1)th trigger (trigger (m−1)) is activated. At this moment, the data driving control chip 1 charges the n×N liquid crystal pixels (P) of the (m−1)th liquid crystal pixel array area (Section (m−1)).

At this moment, the working state of the mth trigger (trigger m) is: the first transistor (M1) and the third transistor (M3) are activated, and the mth pulse signal output end Out(m) is a low pulse signal because the dot clock signal (CLK) is at low voltage level. Now, the mth trigger (trigger m) is in a deactivated state. When the dot clock signal (CLK) is at high voltage level, the mth pulse signal output end Out(m) is a high pulse signal and the mth trigger (trigger m) is activated to control the data driving control chip 1 to charge the n×N liquid crystal pixels (P) of the mth liquid crystal pixel array area (Section (m)).

Because the mth pulse signal output end Out (m) outputs high level pulse signal, the second transistor (M2) and the fourth transistor (M4) of the (m−1)th trigger (trigger (m−1)) are in a activated state and the (m−1)th pulse signal output end Out (m−1) outputs a low level pulse signal.

As aforementioned, M triggers 3 are sequentially activated and controls the data driving control chip 1 to charge the liquid crystal pixels (P) of the respective liquid crystal pixel array areas (Section1˜SectionM).

Please refer to FIG. 3 in conjunction with FIG. 1, FIG. 2a and FIG. 2b. FIG. 3 is a diagram of showing the interconnections of the triggers in the liquid crystal panel shown in FIG. 1. The trigger 1 and trigger 2 connected with each other are taken for illustration. The sources (s1′˜sn′) of the output transistor (T1˜T(n)) in the trigger 1 and the sources (s1′˜sn′) of the output transistor (T1˜T(n)) in the trigger 2 are one by one correspondingly connected and then are one by one correspondingly and electrically connected to the data signal output lines (S1˜S(n)) of the data driving control chip 1; the gates (g1′˜gn′) of the output transistor (T1˜T(n)) in the trigger 1 are electrically connected to the first pulse signal output end Out1 of the trigger 1; the drains (d1′˜dn′) of the output transistor (T1˜T(n)) in the trigger 1 are electrically connected to the liquid crystal pixel data signal lines (Line1˜Line(n)) of the first liquid crystal pixel array area (Section 1); the gates (g1′˜gn′) of the output transistor (T1˜T(n)) in the trigger 2 are electrically connected to the second pulse signal output end Out2 of the trigger 2; the drains (d1′˜dn′) of the output transistor (T1˜T(n)) in the trigger 2 are electrically connected to the liquid crystal pixel data signal lines (Line1˜Line(n)) of the second liquid crystal pixel array area (Section 2). Specifically, the trigger 2 is deactivated when the trigger 1 is activated, and the data driving control chip 1 charges the n×N liquid crystal pixels (P) of the first liquid crystal pixel array area (Section 1); the trigger 1 is deactivated when the trigger 2 is activated, and the data driving control chip 1 charges the n×N liquid crystal pixels (P) of the first liquid crystal pixel array area (Section 1).

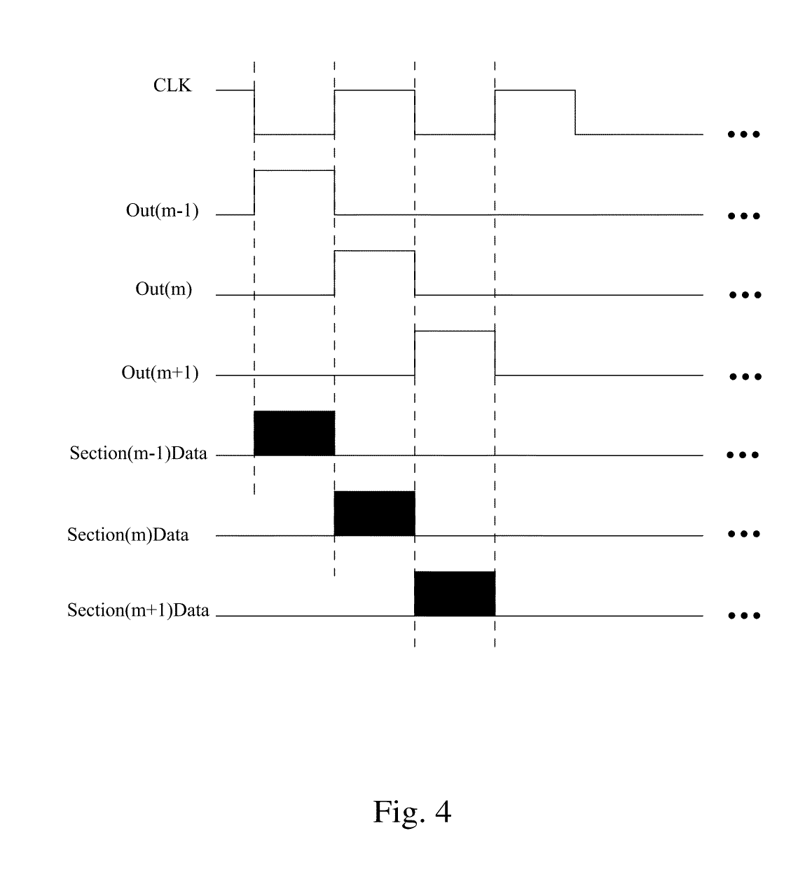

Please refer to FIG. 4 in conjunction with FIG. 1, FIG. 2a, FIG. 2b and FIG. 3. FIG. 4 is a sequence diagram of the liquid crystal panel shown in FIG. 1. Out(m−1), Out(m), Out(m+1) shown in FIG. 3 are the (m−1)th pulse signal output end, the (m)th pulse signal output end and the (m+1)th pulse signal output end, which are employed for connecting trigger(m−1), trigger (m) and trigger (m+1); Section(m−1)Data, Section(m)Data, Section(m+1)Data are data signals of the (m−1)th liquid crystal pixel array area (Section(m−1)), the (m)th liquid crystal pixel array area (Section(m)) and the (m+1)th liquid crystal pixel array area (Section(m+1)) in the liquid crystal pixel array area 4.

As shown in FIG. 4, the working process of the present invention is: M triggers are connected with one another and controlled by the dot clock signal and sequentially triggered. When the trigger m is functioned, the trigger m conducts the liquid crystal pixel (P) of the corresponding mth liquid crystal pixel array area (Section(m)) and the data driving control chip 1. At this moment, the data driving control chip 1 charges the liquid crystal pixel (P) of the corresponding mth liquid crystal pixel array area (Section(m)). Other triggers (trigger1˜trigger(m−1), trigger(m+1)˜trigger(M)) disconnect the liquid crystal pixels (P) of the liquid crystal pixel array areas (Section1˜Section(m−1), Section(m+1)˜Section(M)) and the data driving control chip 1.

Accordingly, by positioning M triggers between liquid crystal pixel data signal lines and the data driving control chip, the liquid crystal panel is correspondingly divided into M liquid crystal pixel array areas. The triggers are sequentially triggered and then sequentially charging the liquid crystal pixels (P) of the M liquid crystal pixel array areas can be achieved without interferes with one another. Charging the liquid crystal pixels (P) of the liquid crystal panel by utilizing the n data signal output lines (S1˜S(n)) of the data driving control chip is realized to enormously reduce the amount of the data signal output lines of the data driving control chip and the manufacture cost of the liquid crystal panel; besides, the activation timing of the triggers is related to the dot clock signal (CLK). Therefore, the charging time of data driving control chip to the liquid crystal pixels (P) of some liquid crystal pixel array areas become controllable. Consequently, the color shift caused by the varying charges to the left, right areas and the middle areas of the liquid crystal panel can be solved.

According to the circuit structure of the liquid crystal panel of the present invention, the present invention also correspondingly provides a driving method of a liquid crystal panel, mainly comprising:

step 100, providing a data driving control chip having n data signal output lines, a column driving scan chip, M triggers, M liquid crystal pixel array areas corresponding to the M triggers;

step 110, each of the liquid crystal pixel array areas comprises: (n×N) liquid crystal pixels, N scan signal lines, and n liquid crystal pixel data signal lines; n liquid crystal pixels are arranged along a column direction; N liquid crystal pixels are arranged along a row direction; the liquid crystal pixel comprises a pixel transistor and a pixel electrode; the pixel transistor comprises a gate, a source and a drain; one end of the pixel electrode is electrically connected to the drain of the pixel transistor, and the other end of the pixel electrode is electrically connected to the common voltage (VCOM); the gates of the pixel transistor arranged in the same column are connected to some common coupling of the scan signal line; the sources of the pixel transistor arranged in the same row are connected to some common coupling of the liquid crystal pixel data signal lines;

step 120, the column driving scan chip and the scan signal lines are electrically connected, and the column driving scan chip 2 activates the scan signal lines sequentially and selectively;

step 130, each of the triggers is positioned between a data driving control chip and a liquid crystal pixel data signal line in a liquid crystal pixel array area, and electrically connected to each of the data signal output lines and the liquid crystal pixel data signal line of the corresponding liquid crystal pixel array area of the data driving control chip; the data signal output lines are one by one correspondingly and electrically connected to the liquid crystal pixel data signal lines of the corresponding liquid crystal pixel array areas;

step 140, sequentially connecting the M triggers with one another;

step 150, the liquid crystal pixel data signal lines in the liquid crystal pixel array areas corresponding to each of the triggers are controlled to be in conducted state together, and each of the triggers controls the data driving control chip to charge the liquid crystal pixels of the corresponding liquid crystal pixel array area.

The driving method of the liquid crystal panel can be understood according to the aforesaid descriptions and FIG. 1, FIG. 2a, FIG. 2b, FIG. 3 and FIG. 4. The repeated explanation is omitted here.

In conclusion, the present invention provides a circuit structure of a liquid crystal panel and a circuit structure of a liquid crystal panel. By positioning M triggers between liquid crystal pixel data signal lines and the data driving control chip, the liquid crystal panel is correspondingly divided into M liquid crystal pixel array areas. The triggers are sequentially triggered and then sequentially charging the liquid crystal pixels of the M liquid crystal pixel array areas can be achieved without interferes with one another. Charging the liquid crystal pixels of the liquid crystal panel by utilizing the n data signal output lines of the data driving control chip is realized to enormously reduce the amount of the data signal output lines of the data driving control chip and the manufacture cost of the liquid crystal panel; besides, the activation timing of the triggers is related to the dot clock signal (CLK). Therefore, the charging time of data driving control chip to the liquid crystal pixels of some liquid crystal pixel array areas become controllable. Consequently, the color shift caused by the varying charges to the left, right areas and the middle areas of the liquid crystal panel can be solved.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A circuit structure of a liquid crystal panel, comprising: a data driving control chip having n data signal output lines, a column driving scan chip, M triggers, M liquid crystal pixel array areas corresponding to the M triggers, a dot clock signal and a common voltage;
each of the liquid crystal pixel array areas comprises: (n×N) liquid crystal pixels, N scan signal lines, and n liquid crystal pixel data signal lines; n liquid crystal pixels are arranged along a column direction; N liquid crystal pixels are arranged along a row direction; the liquid crystal pixel comprises a pixel transistor and a pixel electrode; the pixel transistor comprises a gate, a source and a drain; one end of the pixel electrode is electrically connected to the drain of the pixel transistor, and the other end of the pixel electrode is electrically connected to the common voltage; the gates of the pixel transistor arranged in the same column are connected to some common coupling of the scan signal line; the sources of the pixel transistor arranged in the same row are connected to some common coupling of the liquid crystal pixel data signal lines;
the column driving scan chip and the scan signal lines are electrically connected, and the column driving scan chip activates the scan signal lines sequentially and selectively;
each of the triggers is positioned between a data driving control chip and a liquid crystal pixel data signal line in a liquid crystal pixel array area, and electrically connected to each of the data signal output lines, the dot clock signal and the liquid crystal pixel data signal line of the corresponding liquid crystal pixel array area of the data driving control chip; the data signal output lines are one by one correspondingly and electrically connected to the liquid crystal pixel data signal lines of the corresponding liquid crystal pixel array areas.

2. The circuit structure of a liquid crystal panel according to claim 1, wherein the M triggers are sequentially connected with one another, and the M triggers are controlled by the dot clock signal and sequentially triggered.

3. The circuit structure of a liquid crystal panel according to claim 2, wherein the liquid crystal pixel data signal lines in the liquid crystal pixel array areas corresponding to each of the triggers are controlled to be in conducted state together.

4. The circuit structure of a liquid crystal panel according to claim 3, wherein the triggers control the data driving control chip to charge the liquid crystal pixels of the respective liquid crystal pixel array areas.

5. The circuit structure of a liquid crystal panel according to claim 4, wherein the trigger comprises: a trigger control module and a trigger output module electrically connected to the trigger control module; the trigger control module comprises a first transistor, a second transistor, a third transistor, a fourth transistor and a capacitor; the first transistor comprises a first gate, a first source and a first drain; the second transistor comprises a second gate, a second source and a second drain; the third transistor comprises a third gate, a third source and a third drain; the fourth transistor comprises a fourth gate, a fourth source and a fourth drain; the trigger output module comprises n output transistors, and the output transistors comprise gates, sources and drains;
the first gate and the first source are electrically connected and then form a (m−1)th pulse signal output end Out (m−1), and the second drain is electrically connected to a negative electrode of a power supply, and the third source is electrically connected to the dot clock signal, and the fourth drain is electrically connected to the negative electrode of the power supply, and the second gate and the fourth gate are electrically connected and then form a (m+1)th pulse signal output end Out (m+1), and one end of the capacitor is electrically connected to the first drain and the second source, and then connected to the third gate to form a connection point, and the other end of the capacitor is electrically connected to the third drain and the fourth source and then form a mth pulse signal output end Out (m), and the gates of the n output transistors are electrically connected to the mth pulse signal output end Out (m), the sources of the n output transistors are one by one correspondingly and electrically connected to the data signal output lines of the data driving control chip, and the drains of the n output transistors are correspondingly and electrically connected to the liquid crystal pixel data signal lines of the mth corresponding liquid crystal pixel array area.

6. A circuit structure of a liquid crystal panel, comprising: a data driving control chip having n data signal output lines, a column driving scan chip, M triggers, M liquid crystal pixel array areas corresponding to the M triggers, a dot clock signal and a common voltage;
each of the liquid crystal pixel array areas comprises: (n×N) liquid crystal pixels, N scan signal lines, and n liquid crystal pixel data signal lines; n liquid crystal pixels are arranged along a column direction; N liquid crystal pixels are arranged along a row direction; the liquid crystal pixel comprises a pixel transistor and a pixel electrode; the pixel transistor comprises a gate, a source and a drain; one end of the pixel electrode is electrically connected to the drain of the pixel transistor, and the other end of the pixel electrode is electrically connected to the common voltage; the gates of the pixel transistor arranged in the same column are connected to some common coupling of the scan signal line; the sources of the pixel transistor arranged in the same row are connected to some common coupling of the liquid crystal pixel data signal lines;
the column driving scan chip and the scan signal lines are electrically connected, and the column driving scan chip activates the scan signal lines sequentially and selectively;
each of the triggers is positioned between a data driving control chip and a liquid crystal pixel data signal line in a liquid crystal pixel array area, and electrically connected to each of the data signal output lines, the dot clock signal and the liquid crystal pixel data signal line of the corresponding liquid crystal pixel array areas of the data driving control chip; the data signal output lines are one by one correspondingly and electrically connected to the liquid crystal pixel data signal lines of the corresponding liquid crystal pixel array areas;
wherein the M triggers are sequentially connected with one another, and the M triggers are controlled by the dot clock signal and sequentially triggered;
wherein the liquid crystal pixel data signal lines in the liquid crystal pixel array areas corresponding to each of the triggers are controlled to be in conducted state together;
wherein the triggers control the data driving control chip to charge the liquid crystal pixels of the respective liquid crystal pixel array areas;
wherein the trigger comprises: a trigger control module and a trigger output module electrically connected to the trigger control module; the trigger control module comprises a first transistor, a second transistor, a third transistor, a fourth transistor and a capacitor; the first transistor comprises a first gate, a first source and a first drain; the second transistor comprises a second gate, a second source and a second drain; the third transistor comprises a third gate, a third source and a third drain; the fourth transistor comprises a fourth gate, a fourth source and a fourth drain; the trigger output module comprises n output transistors, and the output transistors comprise gates, sources and drains;
the first gate and the first source are electrically connected and then form a (m−1)th pulse signal output end Out (m−1), and the second drain is electrically connected to a negative electrode of a power supply, and the third source is electrically connected to the dot clock signal, and the fourth drain is electrically connected to the negative electrode of the power supply, and the second gate and the fourth gate are electrically connected and then form a (m+1)th pulse signal output end Out (m+1), and one end of the capacitor is electrically connected to the first drain and the second source, and then connected to the third gate to form a connection point, and the other end of the capacitor is electrically connected to the third drain and the fourth source and then form a mth pulse signal output end Out (m), and the gates of the n output transistors are electrically connected to the mth pulse signal output end Out (m), the sources of the n output transistors are one by one correspondingly and electrically connected to the data signal output lines of the data driving control chip, and the drains of the n output transistors are correspondingly and electrically connected to the liquid crystal pixel data signal lines of the mth corresponding liquid crystal pixel array area.

7. A driving method of a liquid crystal panel, comprising:
step 100, providing a data driving control chip having n data signal output lines, a column driving scan chip, M triggers, M liquid crystal pixel array areas corresponding to the M triggers;
step 110, each of the liquid crystal pixel array areas comprises: (n×N) liquid crystal pixels, N scan signal lines, and n liquid crystal pixel data signal lines; n liquid crystal pixels are arranged along a column direction; N liquid crystal pixels are arranged along a row direction; the liquid crystal pixel comprises a pixel transistor and a pixel electrode; the pixel transistor comprises a gate, a source and a drain; one end of the pixel electrode is electrically connected to the drain of the pixel transistor, and the other end of the pixel electrode is electrically connected to the common voltage; the gates of the pixel transistor arranged in the same column are connected to some common coupling of the scan signal line; the sources of the pixel transistor arranged in the same row are connected to some common coupling of the liquid crystal pixel data signal lines;
step 120, the column driving scan chip and the scan signal lines are electrically connected, and the column driving scan chip activates the scan signal lines sequentially and selectively;
step 130, each of the triggers is positioned between a data driving control chip and a liquid crystal pixel data signal line in a liquid crystal pixel array area, and electrically connected to each of the data signal output lines and the liquid crystal pixel data signal line of the corresponding liquid crystal pixel array area of the data driving control chip; the data signal output lines are one by one correspondingly and electrically connected to the liquid crystal pixel data signal lines of the corresponding liquid crystal pixel array areas;
step 140, sequentially connecting the M triggers with one another.

8. The driving method of the liquid crystal panel according to claim 7, wherein the M triggers are controlled by the dot clock signal and sequentially triggered.

9. The driving method of the liquid crystal panel according to claim 8, wherein the liquid crystal pixel data signal lines in the liquid crystal pixel array areas corresponding to each of the triggers are controlled to be in conducted state together.

10. The driving method of the liquid crystal panel according to claim 9, wherein the triggers control the data driving control chip to charge the liquid crystal pixels of the respective liquid crystal pixel array areas.

11. The driving method of the liquid crystal panel according to claim 10, wherein
the trigger comprises: a trigger control module and a trigger output module electrically connected to the trigger control module; the trigger control module comprises a first transistor, a second transistor, a third transistor, a fourth transistor and a capacitor; the first transistor comprises a first gate, a first source and a first drain; the second transistor comprises a second gate, a second source and a second drain; the third transistor comprises a third gate, a third source and a third drain; the fourth transistor comprises a fourth gate, a fourth source and a fourth drain; the trigger output module comprises n output transistors, and the output transistors comprise gates, sources and drains;
the first gate and the first source are electrically connected and then form a (m−1)th pulse signal output end Out (m−1), and the second drain is electrically connected to a negative electrode of a power supply, and the third source is electrically connected to the dot clock signal, and the fourth drain is electrically connected to the negative electrode of the power supply, and the second gate and the fourth gate are electrically connected and then form a (m+1)th pulse signal output end Out (m+1), and one end of the capacitor is electrically connected to the first drain and the second source, and then connected to the third gate to form a connection point, and the other end of the capacitor is electrically connected to the third drain and the fourth source and then form a mth pulse signal output end Out (m), and the gates of the n output transistors are electrically connected to the mth pulse signal output end Out (m), the sources of the n output transistors are one by one correspondingly and electrically connected to the data signal output lines of the data driving control chip, and the drains of the n output transistors are correspondingly and electrically connected to the liquid crystal pixel data signal lines of the mth corresponding liquid crystal pixel array area.
